(19) United States
(12) Patent Application Publication
(10) Pub. No.: US 2006/0141233 A1
(43) Pub. Date: Jun. 29, 2006

(54) Pre-filter material

(76) Inventor: Antonio Giangrasso, Nurnberg (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 10/531,362

(22) PCT Filed: Oct. 14, 2003
(86) PCT No.: PCT/EP03/11383

§ 371 Date: Apr. 14, 2005

(30) Foreign Application Priority Data
Oct. 16, 2002 (DE) 10248201.2
Oct. 16, 2002 (DE) 20215896.9

(51) Int. Cl. D04H 1/54; B32B 3/26

(52) U.S. Cl. 428/304.4; 264/126

(57) ABSTRACT

The invention relates to a plastic moulded body which comprises irregularly sintered granulate plastic particles having a density of 0.6 1.2 g/cm³ and a bulk density (DIN-ISO 60) of 150-250 g/l. The inventive plastic moulded bodies are extremely well-suited for use as a pre-filter material in the form of a bed.

The invention relates to a plastic molded body, a method for the production thereof and its use in the form of a bed as a prefilter material.

Prefilters are conventionally used in order to filter coarse-grained particles, such as dirt particles, from a solution prior to further purifying the same by downstream finer filters. The use of prefilters is necessary to prevent the fine filters from being occluded by coarse particles and their filter performance from being impaired thereby.

Very often sand, chippings, extrusive rocks and ceramic tubes are used as prefiltering materials. The filtering characteristics of said materials are created by using them as beds. The use of sand, chippings and extrusive rocks is, however, often disadvantageous since these materials show only a minor filter efficiency in relation to their weight. Moreover, sand and chippings can only be cleaned with difficulty due to the relatively small particles of which the bed is composed. Ceramic tubes furthermore exhibit the disadvantage that ceramic particles may dissolve from the tubes during filtration which leads to undesired impurities of the filtrate.

It is furthermore known to use cotton wool as a pre-filter material in order to filter coarse dirt particles from a solution. However, cotton wool shows the disadvantage that it is relatively easily clogged and can only be cleaned with difficulty.

Therefore, the object underlying the invention consists in providing a pre-filter material having a low weight which can easily be cleaned, exhibits a minor pressure loss and shows a high efficiency during filtration even with a minor bed height.

This object is solved by a plastic molded body which comprises irregularly sintered granulate plastic particles having a density of 0.6 to 1.2 g/cm³ and which has a bulk density of 150 to 250 g/l.

Plastic molded bodies of this kind can be used as advantageous pre-filters in the form of a bed.

For the preparation of a plastic molded body according to the invention which may be used as a pre-filter material in the form of a bed, the plastic in the form of a coarse granulate is irregularly filled into a sintering mold and heated therein to a temperature which is so high that the plastic granulate begins to melt on the surface, but does not melt through completely. Thereby, the plastic granulate is sintered at the contacting surfaces and, following cooling, a stable sinter bond is obtained, i.e. the plastic molded body according to the invention.

The plastic which is used in the form of a coarse granulate may be any commercially available plastic having a density of 0.6 to 1.2 g/cm³, preferably 0.8 to 1.0 g/cm³ and being available as granulate. Polyethylene and polypropylene are preferably used. It is also possible to use a mixture of different plastics, whereas it is to be taken into consideration in this regard that the granulate surfaces should have similar start-melt-point temperatures.

As regards their start-melt-point temperatures, the granulate particles preferably have a Vicat softening temperature in the range from 60 to 100° C., especially preferred from 70 to 90° C. A plastic having a Vicat softening temperature in the range indicated above usually has a start-melt-point temperature of between 80 and 220° C. which is particularly well-suited for the preparation of the plastic molded body according to the invention.

The plastic granulate particles may have an arbitrary shape and are preferably of a platelet-like, cylinder, spherical or lenticular shape, particularly preferably of a platelet-like or lenticular shape. It is preferred that the granulate particles have an average size in the range from 2 mm to 10 mm, especially preferred from 4 mm to 7 mm. In the case of spherical or lenticular granulate particles, the “average size” means the diameter. The platelet-like granular particles may be round, oval, ellipsoidal or irregular. The “average size” in the case of the platelet-like granular particles means the largest diameter. The thickness of the platelets is preferably 0.05 to 2.5 mm. It is also possible that a mixture of different granulate forms is used to attain a degree of irregularity in the resulting plastic molded body which is as high as possible. The degree of irregularity is of importance, in particular, when using the plastic molded body as a pre-filter material, since the irregularities create turning points in the passing through of a liquid. The more tuning points exist, the greater the filtering effect.

The plastic molded body according to the invention, as a bed, further has a bulk density in the range from 150 to 250 g/l, preferably in the range from 150 to 200 g/l. The bulk density is a measure for the irregularity with which the granulate particles are sintered. The more irregular the granulate particles are present in the plastic molded body and the smaller the melted contact surfaces of the granulate particles, the smaller the bulk density. Furthermore, the bulk density is dependent on the size of the granulate particles used, i.e. the smaller the used granulate particles, the higher the bulk density of the molded body produced from the granulate particles.

The plastic molded body according to this invention may have an arbitrary size and shape. Preferably, it has a platelet-like shape, with the surface of the platelet being round. The diameter of the platelet is preferably in the range from 1 to 10 cm, especially preferred is from 2 to 6 cm. The thickness of the platelet is preferably in the range from 0.5 to 2 cm.

The plastic molded body according to the invention preferably has a specific surface in the range from 15 to 80 cm²/g, especially preferred is from 20 to 40 cm²/g. The size of the surface can be adjusted by means of the size of the used granulate particles, with smaller granulate particles resulting in larger surfaces for the plastic molded body. Furthermore, the surface is influenced by the degree of sintering, with smaller sintering contact surfaces between the granulate particles creating larger surfaces in the resulting plastic molded body according to the invention.

The plastic molded body according to the invention itself may be porous or unporous, i.e. there may be free spaces between the individual granulate particles or not.

In the following, description will be made in further detail of the method for producing the plastic molded body according to the invention.

The method comprises the following steps:
(a) filling at least two layers of plastic granulate particles into a mold,
(b) homogenously heating the plastic granulate particles in a sintering oven to a temperature, at which the plastic granulate particles merely start melting at the surface, but do not melt through completely,
(c) cooling to room temperature and
(d) demolding the sintered plastic molded body from the mold.

In step (a), the plastic granulate particles are filled into a mold, with the filling amount being supposed to be at least two layers of polymer granulate. It is advantageous if the granulate particles are present in the sintering mold as irregular as possible and have contact surfaces which are as small as possible. For this purpose, the granulate particles are filled into the mold through a slot nozzle, whereby a random, irregular bed is obtained. The sintering mold is of an arbitrary size and shape and can be selected dependent on which size and shape the resulting plastic molded body is desirably supposed to have.

The heating described in step (b) is effected in a sintering oven, whereby the plastic granulate is homogenously heated from all sides. The temperature to which the plastic granulate is heated in order to achieve melting of its surfaces is dependent on the selected plastic. The temperature for polyethylene and polypropylene is conventionally between 80 and 220° C. The start-melt-point temperature is achieved when the plastic material, of which the granulate particles consist, adopts a glassy appearance. Heating is preferably effected for 5 to 60 minutes, especially preferably for 15 to 20 minutes.

In step (c), the surface-melted plastic granulate particles are cooled to room temperature. Cooling is preferably effected very fast, i.e. by quenching, e.g. by means of blowing in cold air. Following thereafter, the cooled plastic molded body is demolded from the mold in a step (d).

The plastic molded body according to the invention is excellently suitable for use as a pre-filter material. For this purpose, it is used in the form of a loose bed. Due to the irregular structure of the individual plastic molded body according to the invention, swirls, also referred to as turning points, are created when liquid is passing therethrough. These turning points create the filtering effect and particles present in the liquid which, is to be filtered remain at the plastic molded bodies while the liquid flows through the bed. In order to attain an excellent filtering effect, a minor bed height is already sufficient due to the plurality of turning points. The bed of the plastic molded body according to the invention which can be used as a pre-filter material has the advantage that it exhibits a minor loss of pressure when liquid is passing therethrough, has a minor weight, is chemically stable and can be easily cleaned.

### EXAMPLE

5.5 g of granulate particles of polyethylene having a high density (Hostalen® GM 6255, produced by Elenac) are filled into a round sintering mold having a diameter of 55 mm. The used polyethylene shows a density (23° C., ISO 1183) of 0.951 g/cm³ and a Vicat softening point B/50 (ISO 306) of 84° C.

The mold which is filled with the granulate particles is heated for 20 minutes in a sintering oven to a temperature of 210° C. During this temperature treatment, the granulate particles start to melt on the surface and can thus melt with each other at their contact surfaces. Following thereafter, the mold is removed from the oven and the molded body is quenched by blowing in cold air. The plastic molded body thus obtained has a specific surface of between 20 to 40 cm²/g and, in the form of a bed, a bulk density of 160 to 180 g/l.

Determination of the Bulk Density:

The bulk density was determined according to DIN-ISO 60.

Determination of the Specific Surface:

The specific surface of the plastic molded body according to the invention is determined by measuring by means of a caliper. It is thereby presumed, as was also experimentally confirmed by Krypton-gas adsorption, that the plastic granulate used for the plastic molded body does not exhibit microporosity on its surface.

When determining the specific surface, the granulate particles forming the plastic molded body of 10 plastic bodies are measured by means of a caliper. The proportion of contact surfaces, at which the granulate particles are melted with each other and which do not contribute to the surface, are deducted thereby. The surfaces thus determined are related to 1 g of the plastic molded body, with the weight being determined by means of weighing.

1. Plastic molded body which comprises irregularly sintered plastic granulate particles having a density of 0.6 to 1.2 g/cm³ and which has a bulk density according to DIN-ISO 60 of 150 to 250 g/l, said granulate particles having a size in the range from 2 mm to 10 mm.

2. Plastic molded body according to claim 1, wherein the bulk density is in the range from 150 to 200 g/l.

3. The plastic molded body according to claim 1, wherein the plastic granulate particles are of polyethylene or polypropylene.

4. The plastic molded body according to claim 1, wherein the plastic granulate particles are lenticular.

5. A method for producing the plastic molded body of claim 1, comprising the steps of:
(a) filling at least two layers of plastic granulate particles into a mold, said granulate particles having a size in the range from 2 mm to 10 mm,
(b) heating the plastic granulate particles to a temperature, at which the plastic granulate particles merely start melting at the surface, but do not melt through completely,
(c) cooling to room temperature, and
(d) de-molding the sintered plastic molded body from the mold.

6. The method according to claim 5, wherein the cooling in step (c) is a quenching.

7. (canceled)

8. A bed of the plastic molded bodies of claim 1.

9. The method according to claim 5, wherein the plastic granulate particles are of polyethylene or polypropylene.

10. The method according to claim 5, wherein the plastic granulate particles are lenticular.

11. A pre-filter material comprising plastic molded bodies of claim 1.

12. The pre-filtered material according to claim 11, wherein the plastic granulate particles are of polyethylene or polypropylene.

13. The pre-filtered material according to claim 11, wherein the plastic granulate particles are lenticular.

14. The pre-filter material of claim 11, wherein the material has a form of a bed.

15. The pre-filter material of claim 12, wherein the material has a form of a bed.

16. The pre-filter material of claim 13, wherein the material has a form of a bed.
